(19) United States
(12) Patent Application Publication
(10) Pub. No.: US 2025/0060883 A1
(43) Pub. Date: Feb. 20, 2025

(54) PSEUDORANDOM DATA PROGRAMMING IN A MEMORY

(71) Applicant: INTERNATIONAL BUSINESS MACHINES CORPORATION, Armonk, NY (US)

(72) Inventors: Nikolaos Papandreou, Thalwil (CH); Roman Alexander Pletka, Uster (CH); Radu Ioan Stoica, Zurich (CH); Charalampos Pozidis, Thalwil (CH)

(21) Appl. No.: 18/449,764

(22) Filed: Aug. 15, 2023

(51) Int. Cl. G06F 3/06

(52) U.S. Cl. CPC G06F 3/0616; G06F 3/0658; G06F 3/0679

(57) ABSTRACT

In one aspect of pseudorandom data programming in accordance with the present description, on-board die pseudorandom data is written to a target page if retired. In one embodiment, on-board die pseudorandom data is generated using a pseudorandom data generator on-board the storage die. A command issued to the storage die includes a pattern identification (ID) which identifies a pseudorandom data generator on-board the storage die, to generate a pattern of pseudorandom data. In yet another aspect, pseudorandom data is pre-stored in an internal source buffer of the storage die. In still another aspect, timing of an interval of time is initiated and, on-board die pseudorandom data is written to a selected target page if the timed interval of time has exceeded the predetermined interval of time.

### BACKGROUND OF THE INVENTION

### 1. Field of the Invention

The present invention relates to a memory system, and method for programming memory cells with pseudorandom data.

### 2. Description of the Related Art

Solid state storage devices such as, for example, solid state drives or SSDs, may be comprised of one or more packages of non-volatile memory dies implementing NAND memory cells, where each die is comprised of one or more arrays of storage cells. Storage cells are organized into pages and pages are organized into blocks, and the blocks are stored in planes of a storage die. In a NAND memory having NAND memory cells, such as a NAND flash memory, the pages in a block of the memory are programmed sequentially according to a page program order.

NAND flash memory may utilize memory cells which have the capability of storing data in multiple levels. For example, a quad level cell (QLC) stores 4 bits per cell, i.e., QLC NAND stores data in sixteen levels. By comparison, a single level cell (SLC) stores 1 bit per cell, i.e., SLC NAND stores data in two levels.

The pages in a block of memory may show significant variations in raw bit error rate (RBER) due to process variations, usage variations, and other factors. Typically, when the RBER of a page in a block hits a maximum threshold value, the entire block is retired and becomes unused. However, it has been proposed to retire portions of a block at the page or other sub-block level, such that retirement is more closely limited to the high-RBER pages of the block. As a result, the remaining portion of the block which has not yet reached high-RBER level, may remain active and usable for storing user data. Thus, the usable lifetime of the block may be extended but at a reduced capacity.

Once retired, the retired pages of a block are not used to store user data. However, it has been proposed to fill the retired pages with pseudorandom data as user data is written to neighboring unretired or active pages to preserve the page program order for the block and to maintain the reliability of the user data being stored in neighboring active pages of the block.

In NAND flash memory devices, pages already containing data cannot be updated with new data without the entire block of pages being erased. To free up blocks of pages to receive new data, the existing valid data of the block is typically consolidated and written to a new block to fill up all the pages on that new block, and the blocks previously storing the dispersed pages may then be erased to be made available for new data.

A memory device such as a NAND flash memory, for example, is typically controlled by a controller which receives user data or other data from a host, and transmits that host data to the memory device to be stored in the erased pages of the memory device in the page program order. In modern three-dimensional NAND flash memory devices, the pages of a block are typically organized in layers which are filled with host data from the controller in sequential order according to the page program order. The host data transmitted to the memory device by the controller in anyone write operation or sequence of write operations may be insufficient to fill an entire block with host data. Accordingly, one or more layers of the block at the boundary of the pages programmed with host data, may continue be in the erased or open state following completion of a write operation or a sequence of write operations directed to that block. If additional host data arrives, programming of the open pages in that block may continue in the page program order until either the block becomes full or the controller switches the programming to a different block such that pages or layers beyond the boundary of programmed pages are not programmed with host data.

It is known that leaving pages of the block in the erased state may increase the RBER of neighboring layers in that block which have been programmed with host data. Accordingly, it has been proposed for the controller to transmit dummy data such as pseudorandom data or specific patterned data to the memory device to fill any remaining open pages or open layers of the block if the block is not to be filled to capacity with host data. As memory devices grow in capacity, the likelihood of a block of memory not being filled to capacity with host data within a given time interval may increase.

Flash memory devices often have a built-in internal data transfer mechanism referred to as a copyback read and copyback program operation. The controller can transmit a copyback command to the memory device in which the parameters of the copyback read or copyback program command include the address of a source page of data to be read or a target page to be programmed, respectively. In response to receipt of the copyback read command, the memory device internally copies the data stored in the source page to an internal buffer, whereas, in response to receipt of the copyback program command, the memory device internally copies the data stored in the internal buffer to the target page. In one known NAND memory device, the source page is a page of a block of SLC type memory cells, and the target page is a page of a block of QLC type memory cells to provide an SLC to QLC copyback operation.

### SUMMARY

Provided are a memory system, computer program product and method for use with a host, in which the memory system comprises a plurality of storage dies having blocks of pages of memory for storing data, and a memory controller coupled to the plurality of storage dies and having a processor. In one aspect of pseudorandom data programming in accordance with the present description, in response to a determination that a selected first target page is a retired page instead of an active page, on-board die pseudorandom data is written to the selected first target page which is retired. In one embodiment, in response to receiving by the memory controller from a host, write data to be written to a storage die, writing data to a target block of pages of the storage die is initiated including initiating a page counter to identify a target page of a sequence of target pages of the target block of pages of the storage die for writing data to the target block. A first target page of a sequence of target pages of the target block of pages of the storage die is selected to write data, as a function of the page counter, and a determination is made as to whether the selected first target page is a retired page instead of an active page. In response to a determination that the selected first target page is a retired page instead of an active page, on-board die pseudorandom data is written to the selected first target page which is retired, and the page counter is updated to select a second in-sequence target page of the target block of pages of the storage die to write data.

In another aspect of pseudorandom data programming in accordance with the present description, each storage die has at least one pseudorandom data generator on-board the storage die, and the operations further comprise generating the on-board die pseudorandom data using a pseudorandom data generator on-board the storage die. In one embodiment, writing on-board die pseudorandom data to the selected first target page includes the memory controller issuing a command to the storage die wherein the command has parameters which include an address of a target page, a pattern identification (ID) which identifies a pseudorandom data generator of a plurality of pseudorandom data generators on-board the storage die, to generate a pattern of pseudorandom data, and a parameter identifying the number of pages of on-board die pseudorandom data to be written to target pages.

In yet another aspect of pseudorandom data programming in accordance with the present description, each storage die has an internal source buffer, and wherein the operations further include the memory controller pre-storing pseudorandom data in an internal source buffer of the storage die so that the pre-stored pseudorandom data is on-board the internal source buffer of the storage die prior to initiating writing data to the target block of pages of the storage die.

In still another aspect of pseudorandom data programming in accordance with the present description, in response to a determination that the selected first target page is an active page instead of a retired page, received host write data is written to the selected first target page of the storage die and the page counter is updated to select a second in-sequence target page of the target block of pages of the storage die to write data.

In still another aspect of pseudorandom data programming in accordance with the present description, the operations further comprise, in association with updating the page counter to select a second in-sequence target page of the target block of pages of the storage die to write data, timing of an interval of time is initiated and a determination is made as to whether the timed interval of time has exceeded a predetermined interval of time. In one embodiment, in response to a determination that the timed interval of time has exceeded the predetermined interval of time, on-board die pseudorandom data is written to the selected second target page, and the page counter is updated to select a third in-sequence target page of the target block of pages of the storage die to write data. Conversely, in response to a determination that the timed interval of time remains within the predetermined interval of time, a determination is made as to whether received host write data includes page write data available for writing to the selected second target page of the target block of pages of the storage die. In response to a determination that received host write data includes page write data available for writing to the selected second target page of the target block of pages of the storage die, received host write data is written to the selected second target page of the storage die, the page counter is updated to select a third in-sequence target page of the target block of pages of the storage die to write data, and timing of an interval of time is reset and re-initiated.

Other aspects and advantages may be realized, depending upon the particular application.

### BRIEF DESCRIPTION OF THE DRAWINGS

FIG. 1 illustrates an embodiment of a computer system having a non-volatile memory storage device employing pseudorandom data programming in accordance with the present description.

FIG. 1A illustrates an embodiment of an interface controller on-board a memory die of a computer system of FIG. 1 employing pseudorandom data programming in accordance with the present description.

FIG. 2 illustrates an embodiment of operations performed by a storage controller employing pseudorandom data programming for retired pages in accordance with the present description.

FIGS. 3, 3A illustrate embodiments of programming retired pages of a block of memory, with on-board pseudorandom data in accordance with the present description.

FIG. 3A illustrates a more detailed embodiment of programming retired pages of a block of memory, with on-board pseudorandom data in accordance with the present description.

FIG. 4A illustrates a format of a known command string which includes transmitted data for programming pages of a memory device.

FIGS. 4B, 4C illustrate formats of known copyback commands which lack transmitted data for programming pages of a memory device.

FIG. 4D illustrates a format of a multiple page command string employing pseudorandom data programming in accordance with the present description for generating pseudorandom data on-board a memory die for programming multiple pages of the memory die.

FIG. 5 illustrates an embodiment of operations performed by a storage controller employing pseudorandom data programming for open pages in accordance with the present description.

FIGS. 6, 6A, 6B illustrate embodiments of programming open pages of a block of memory, with on-board die pseudorandom data in accordance with the present description.

FIG. 7 depicts a computing environment in which the components of FIG. 1 may be implemented.

### DETAILED DESCRIPTION

Pseudorandom data programming in accordance with the present description is believed to provide significant improvements to computer technology. In one aspect, retired pages in a block of memory, are programmed with on-board die pseudorandom data to preserve the sequential programming order and to enhance block reliability.

In one embodiment, a storage controller programs a generator circuit on-board a memory die such as a NAND flash memory die, for example, to generate a pseudorandom data pattern from a set of pseudorandom data patterns so that pseudorandom data is already on-board the memory die. As result, since a retired page of the block may be programmed with on-board pseudorandom data already residing on the die, transmission of pseudorandom data over a bus interface between the controller and the memory die, for purposes of programming a retired page with pseudorandom data may be substantially reduced or eliminated. Thus, the on-board pseudorandom data pattern generator and subsequent programming of a target retired page with the on-board die generated pseudorandom data pattern can provide for a beneficial reduction in traffic over the bus interface such that increased bus interface bandwidth may be made available for the benefit of other memory operations.

In one embodiment, a storage controller programs a buffer on-board a memory die such as a NAND flash memory die, for example, with pseudorandom data so that pseudorandom data is already on-board the memory die as an available reference prior to initiating programming of a block of memory with host data. As result, since a retired page of the block may be programmed with on-board pseudorandom data already residing on the die, transmission of pseudorandom data over a bus interface between the controller and the memory die, for purposes of programming a retired page with pseudorandom data may be substantially reduced or eliminated. Thus, the on-board pseudorandom data reference buffer such as a NAND flash memory block, for example, can provide for a beneficial reduction in traffic over the bus interface such that increased bus interface bandwidth may be made available for the benefit of other memory operations.

In another aspect of pseudorandom data programming, not only retired pages but also active pages may be selectively programmed with on-board die pseudorandom data in accordance with the present description. In one embodiment, a timer records the interval of time between subsequent host data page program operations for a particular block. Upon determining that the timer interval has exceeded a threshold value defining a predetermined interval because host data is not available to program the next page, the next page address in the block may be programmed using on-board pseudorandom data instead of leaving the page in its erased state while awaiting a subsequent host data programming operation. In this manner, neighboring pages extending beyond the boundary of the last programmed pages of an open block may be programmed using on-board pseudorandom data. As a result, it is believed that the reliability of the neighboring pages in the previously programmed layer of pages programmed with host data, may be improved.

In one embodiment, a known flash memory command referred to as copyback command may be utilized to program a retired or active page with on-board pseudorandom data which is already pre-stored on the NAND flash memory die. First, a copyback read command is utilized to read the pseudorandom data from an on-board reference source page in a NAND flash memory block to an on-board buffer. Second, a copyback program command is utilized to program the data from the buffer to a target page in another NAND flash memory block. A copyback command lacks a data field in one embodiment since the data being copied is already on-board the die.

In another aspect of pseudorandom data programming in accordance with the present description, commands may be employed by a storage controller to internally program multiple pages using the output of an on-board pseudorandom data generator circuit, with a single command or command string. In one example, each die has one or more pseudorandom data generator circuits and a command controller which is modified to execute a command string which provides for internally generating and storing one or more pseudorandom data patterns to on-board internal source buffers and transferring the generated one or more pseudorandom data patterns from the on-board source buffers to program multiple pages of the target block with on-board die pseudorandom data from the pseudorandom data generator circuits of the memory die.

In one embodiment, such a program command string includes a command field which identifies the command as a multiple page on-board pseudorandom program command, a target address field which identifies the starting address or addresses of the target page or pages to be programmed with on-board pseudorandom data, a page number address field which identifies the number of target pages to be programmed, and a pattern ID address field which identifies the particular pattern of on-board pseudorandom data to be generated by the on-board generation circuit for programming the target pages or pages. In the illustrated embodiment, the pattern ID may include for example, the identifier of a particular pseudorandom data generator circuit selected from multiple on-board pseudorandom data generator circuits of the memory die. Each data generator circuit when selected, generates a unique pattern of pseudorandom data for internally programming pages of the memory die.

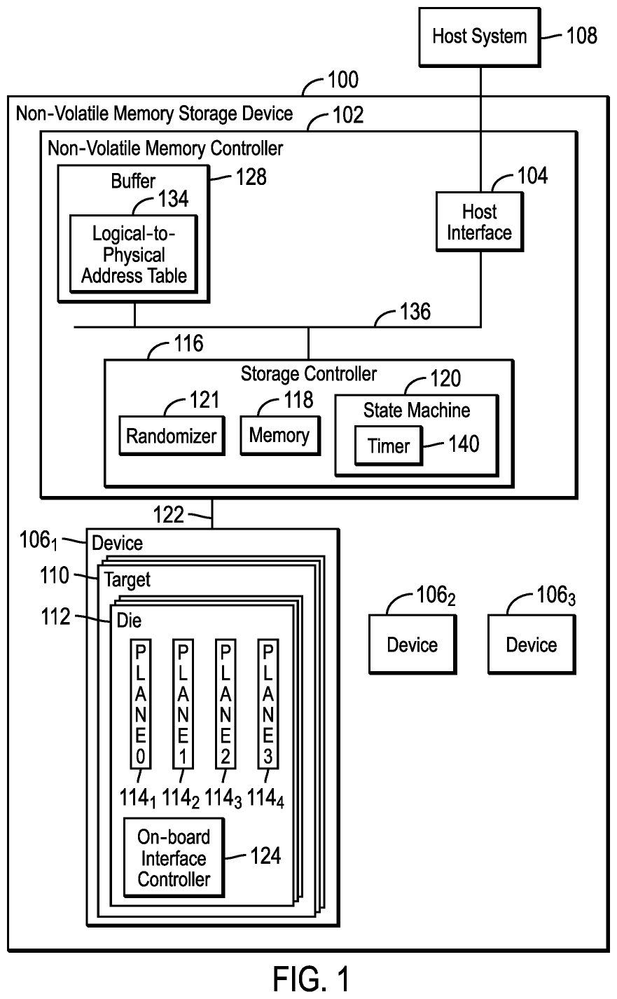

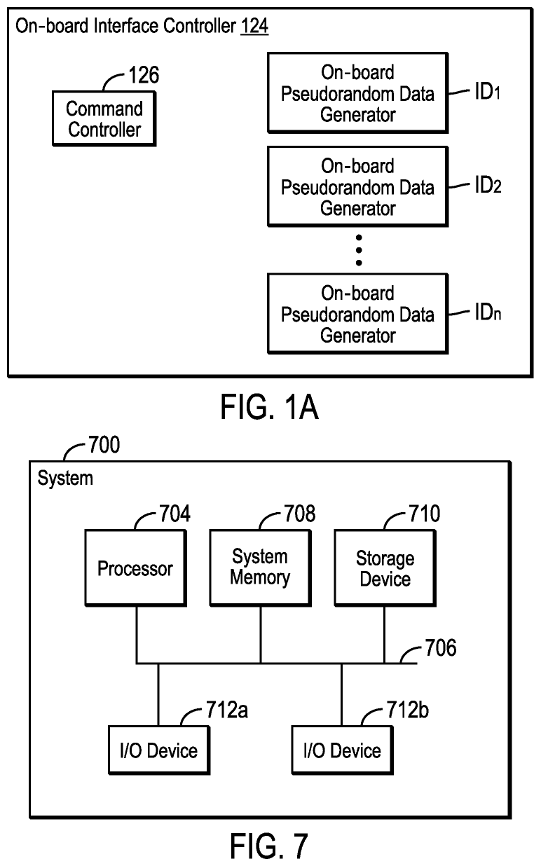

FIG. 1 illustrates an embodiment of a non-volatile memory storage device 100 having a non-volatile memory controller 102, including a host interface 104 to transfer blocks of data and I/O commands between a plurality of groups of devices 106₁, 106₂ . . . 106ₙ, such as NAND chips, and a host system 108. Each device 106₁, 106₂ . . . 106ₙ, may include, as shown with respect to device 106₁, a plurality of targets 110, where each target 110 has one or more dies 112. Each die 112 may be organized as a plurality of planes 114₁, 114₂, 114₃, 114₄ in which the pages of each block of the memory are distributed. In the exemplar embodiment of FIG. 1, there are four planes per die 112. In NAND implementations, the cells forming the pages may comprise floating gates transistors, where cells within a block are connected in a grid connected via a bitline via source/drains and a wordline connects via control gates. The devices 106₁, 106₂ . . . 106ₙ, may have one or more different types of memory cells including Single Level Cell (SLC), Multiple Level Cell (MLC), Triple Level Cell (TLC), Quad Level Cell (QLC) or other level cell level numbers.

The non-volatile memory controller 102 includes one or more storage controllers 116 to perform read and write operations with respect to the pages in the planes 114₁, 114₂, 114₃, 114₄ of a die 112. The storage controller 116, such as a flash memory controller, includes a memory 118. A state machine 120 includes firmware/hardware logic such as a programmed processor or programmed logic, for example, to generate read and write commands to the cells in the planes. The state machine 120 may generate single plane reads or single plane writes directed to a page in a single plane 114; or multi-plane reads or multi-plane writes which are read or write requests to be sent to pages in multiple planes 114₁, 114₂, 114₃, 114₄. A randomizer 121 is employed to randomize data before it is written to the memory cells to facilitate data reliability. The storage controller 116 includes a bus interface 122 to the device 106₁. Each die has an on-board interface controller 124 which includes a command controller 126 which receives and executes the read and write commands generated by the state machine 120 of the storage controller 116. The devices 106₂ . . . 106ₙ may have the same structure and the same or a separate bus interface 122 shown with respect to device 106₁.

The non-volatile memory controller 102 may further include a buffer 128, such as a Dynamic Random Access Memory (DRAM) or other volatile or non-volatile memory device, to store information generated and used by the storage controller 116 during read, write and garbage collection operations. The buffer 128 may further store a logical-to-physical address table 134 providing a mapping of logical addresses to which I/O requests are directed and physical addresses in the devices 106₁, 106₂ . . . 106ₙ at which the data for the logical addresses are stored. The logical addresses may comprise logical block address (LBAs) or other logical addresses known in the art. The logical-to-physical address table 134 is used to determine physical locations in the devices at which data is to be stored.

This architecture of the storage controller 116 and hardware interface 124 may be repeated for different dies, targets, and devices.

The non-volatile memory storage device 100 may function as both a memory device and/or a storage device (for example, a Solid State Drive (SSD)) in a computing system, and may be used to perform the role of volatile memory devices and non-volatile storage media in a computing system. In an embodiment, the non-volatile memory storage device 100 may comprise a non-volatile memory storage device.

In one embodiment, the storage device 100 may comprise a block addressable memory device, such as those based on NAND or NOR technologies. The memory device may use a two-dimensional or three-dimensional NAND array. In one embodiment, the memory device may be or may include memory devices that use chalcogenide glass, multi-level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

The host interface 104 connects the non-volatile memory storage device 100 to a host system 108. The non-volatile memory storage device 100 may be installed or embedded within the host system 108, such as shown and described with respect to element 708 or 710 in FIG. 7, or the non-volatile memory storage device 100 may be external to the host system. The host interface 104 may comprise a bus interface, such as a Peripheral Component Interconnect Express (PCIe) interface, Serial AT Attachment (SATA), Non-Volatile Memory Express (NVMe), etc.

The host interface 104, buffer 128, and one or more storage controllers 116 may communicate over one or more bus interfaces 136, such as a PCIe or other type of bus or interface. In alternative embodiments the connection among any of the components 104, 116, 128 may comprise direct lines or paths and not a shared bus.

A garbage collection process is used with NAND flash memory devices to consolidate valid data written to pages in the memory device to a new block because flash memory is erased before it can be rewritten. Rewriting data in the flash memory requires pages of data to be read, updated, and written to a new location because data cannot be rewritten in place. The block having the source of the data copied to the new location may then be erased and reused.

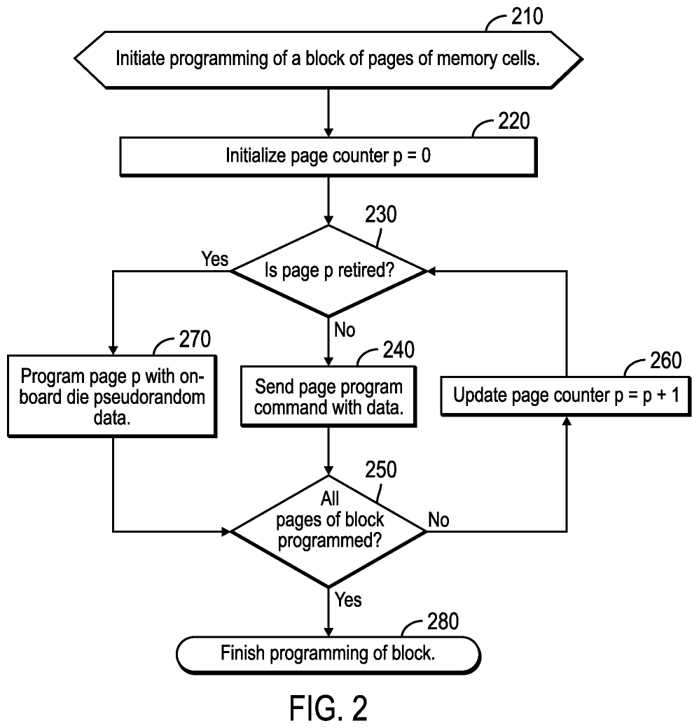

FIG. 2 illustrates an embodiment of operations performed by the storage controller 116 (FIG. 1), in programming pages of a block of an array of memory cells of a memory device, in accordance with one aspect of pseudorandom data programming in accordance with the present description. As explained in greater detail below, retired pages in a block are programmed with on-board pseudorandom data to preserve the sequential programming order and to enhance block reliability. As shown in FIG. 2, the operations of the storage controller 116 in this example are represented by blocks 210-280 of FIG. 2. It is appreciated that the number and types of operations of a storage controller 116 in accordance with embodiments of the present description, may vary, depending upon the particular application. Furthermore, operations may be performed in sequences other than those depicted in FIG. 2. For example, selected operations may be performed in reverse order or substantially in parallel, depending upon the particular application.

In the embodiment of FIG. 2, the operations include initiating (block 210, FIG. 2) programming of a block of pages of an array of memory cells. In this example, a block of memory pages to be programmed is initially erased so that each page of the block of memory pages being programmed is initially in an erased state prior to being programmed.

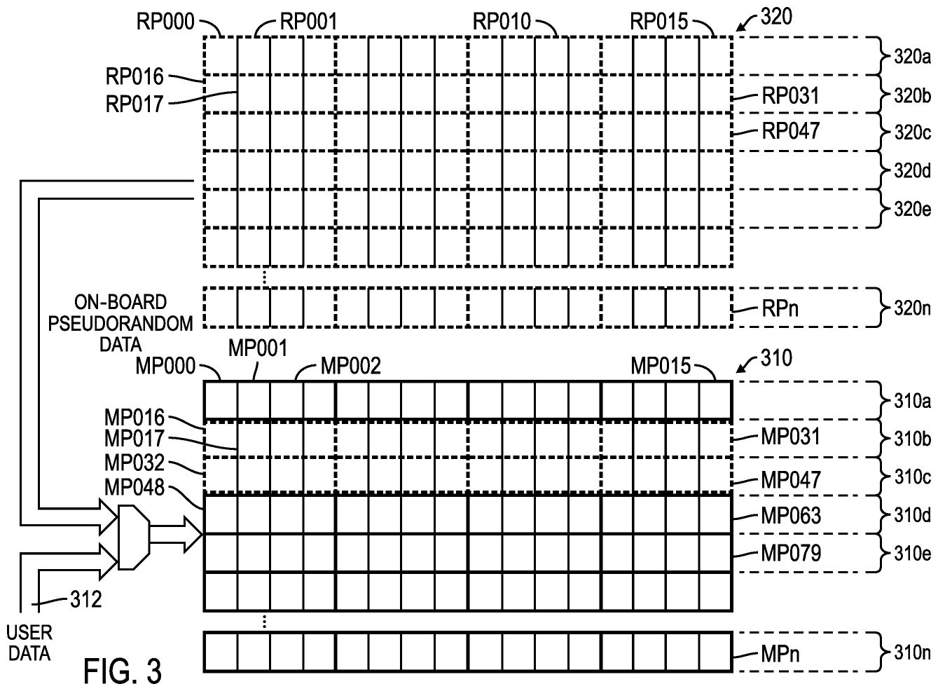

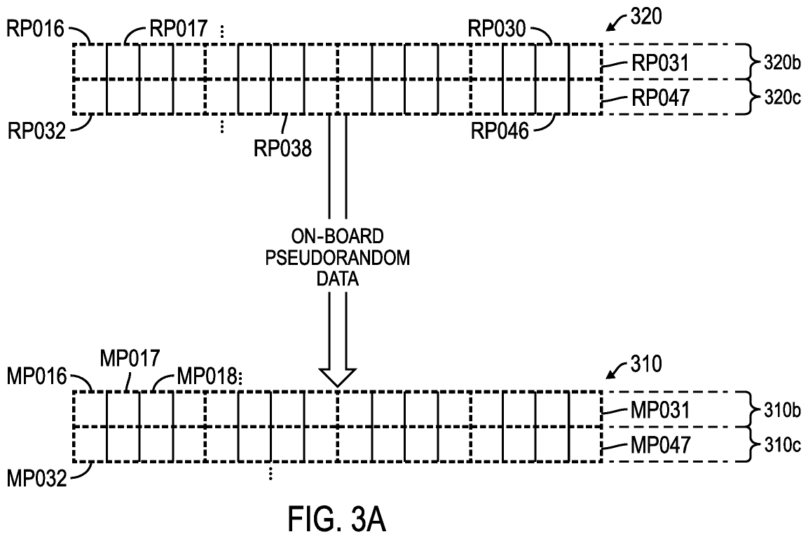

FIG. 3 depicts an example of a block 310 of pages of an array of NAND type memory cells of a die 112 (FIG. 1) in which pages have been selectively programmed with either host user data or on-board die pseudorandom data in accordance with the present description. In this example, the page addresses MPx are sequentially numbered as MPx=MP000, MP001 . . . . MPₙ of the array of NAND type memory cells of the die 112 (FIG. 1). The block 310 is, in this example, a target block which was targeted to be programmed with data by the storage controller 116 as shown in FIG. 3. The pages located at the page addresses MP000, MP001 . . . . MPₙ of the block 310 are referred to herein as simply the pages MP000, MP001 . . . . MPₙ, respectively, for simplicity sake. Thus, the pages MP000, MP001 . . . . MPₙ, are arranged in layers 310ₐ, 310_{b} . . . 310ₙ in this example. Each layer 310ₐ, 310_{b} . . . 310ₙ in this example, includes 16 pages that represent 4 quadruples of shared pages per layer. In some applications, the shared pages of each quadruple are denoted as lower page (LP), upper page (UP), extra page (XP), top page (TP). It is appreciated that the organization of a block of memory may vary depending upon the particular application. For example, the number of pages per layer may vary, the number of layers per block may vary, the number of pages per block may vary, the page numbering scheme may vary, etc.

FIG. 3 depicts the pages of the block 310 upon completion of programming of the pages of the block by the storage controller 116. FIG. 2 is directed to the operations of the storage controller to achieve the programming state of the pages as depicted in FIG. 3.

In the illustrated embodiment, the pages MP000, MP001 . . . . MP0ₙ (FIG. 3) of the block 310 are programmed by the storage controller 116 (FIG. 1) in a page program order which is sequential and starts page programming at the first page MP000 of the sequence of pages of the block 310 and programs each subsequent page in a defined sequential order. Accordingly, to program the block 310 of initially erased memory pages, a page counter p is initialized (block 220, FIG. 2) at p=0 which points to the first erased page MP000 (FIG. 3) of the sequence of pages of the block 310. In this manner, a target page of a block of pages of the memory to write data, is selected as a function of the page counter. In this example, page MP000 is identified as the initial target page of the block 310 of pages for page writing data.

A determination (block 230, FIG. 2) is made as to whether the page at p=0, that is target page MP000 in this example, is retired. In the illustrated embodiment, pages are retired by the storage controller 116 (FIG. 1) when the raw bit error rate (RBER) of a particular page reaches a defined threshold level which has been selected for retirement of pages. The storage controller 116 keeps track of which pages have been retired and which pages remain active. In this example, the storage controller 116 (FIG. 1) determines (block 230, FIG. 2) that the target page MP000 is not retired, that is, that the target page MP000 remains active. Accordingly, the storage controller 116 sends (block 240, FIG. 2) an appropriate page program command string to program the target page MP000 with host data which is transmitted over the bus interface 122 (FIG. 1) to the die 112 which has the target block 310 (FIG. 3) of the array of memory cells to be programmed. The programming of the active target page MP000 with host data transmitted over the bus interface 122 and received by the die 112, is represented in FIG. 3 by a solid line box outlining the target page MP000. The host data received by the die 112 over the bus interface 122 is represented as “User Data” 312 in FIG. 3.

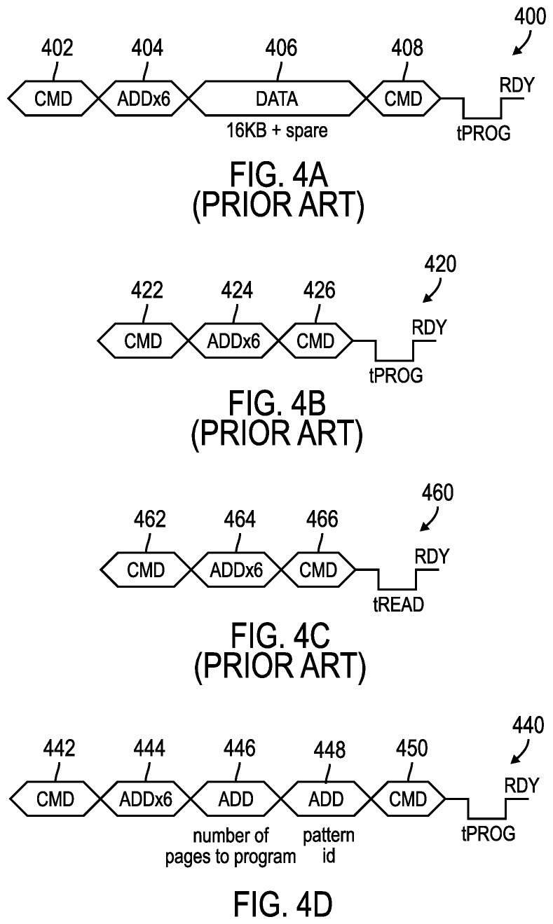

FIG. 4A depicts an example of a suitable known page program command string 400 which is issued by a storage controller such as the storage controller 116 of FIG. 1. As indicated therein, the program command string 400 includes a command field 402 which identifies the command as a page program command, a target address field 404 which identifies the address of the target page to be programmed with data provided by a data field 406 of the program command string 400. In one embodiment, commands, addresses and read/write data are transmitted over separate busses of the bus interface 122 (FIG. 1) coupling the storage controller 116 to the flash memory dies 112 which contain the array or arrays of memory cells to be programmed or read. In the example of FIG. 4A, the address field 404 indicates that 6 address cycles are needed to provide the address information. Other applications may require less or more address cycles.

Once the data of the data field 406 has been loaded in the target die 112, a second command identified by a field 408 of the string 400 causes the target die 112 to execute the programming of the data of field 406 in the selected target page identified by address field 404. In the example of FIG. 3, the programming of a page with host data is represented by the solid line box outlining the quadruple of shared pages which includes the target page MP000. In some applications, the memory die 112 receives one more sets of commands strings 400 corresponding to the data to be programmed in one or more shared pages, i.e., pages that share to the same group of memory cells in the same word-line, and in this case, the last command field 408 causes the target die 112 to execute the programming of the data of the fields 406 that correspond to the shared pages to be programmed in the same program operation.

In this example, the program command string 400 programs a single page, that is target page MP000 with the data contained within the field 406 which is transmitted over the bus interface 122 (FIG. 1) to the die 112 which has the target block 310 (FIG. 3) of an array of memory cells within the die 112. In the illustrated embodiment, the data contained within the field 406 may include user data and error correcting code data, for example. In one embodiment the data field 406 may contain 16 KB of bits plus spare bits, for example. It is appreciated that the number of bits transmitted by a page program command may vary, depending upon the particular application. It is further appreciated that the data field 406 may contain other types of data to be programmed by the storage controller 116 in the target block 310. Furthermore, although the program command string 400 is described in this example of programming a single page, it is appreciated that in other examples and embodiments, program command strings may be employed by a storage controller 116 to program multiple pages with a single command string, e.g., multi-plane page program command strings.

A determination (block 250, FIG. 2) is made as to whether all the pages of the block have been programmed. In this example of FIG. 2, so far only page MP000 has been programmed. Accordingly, the page counter p is incremented (block 260, FIG. 2) so that p=p+1 which points to the next page MP001 in the sequence of pages of the block 310 to be programmed. In this manner, page MP001 is identified as the next-in-sequence target page of the block 310 of pages for writing data.

In the illustrated embodiment, the pages MP000, MP001 . . . . MP015 (FIG. 3) of the first layer 310ₐ of pages of the block 310 are each active, that is, not retired. Accordingly, the next-in-sequence target page MP001 is determined (block 230, FIG. 2) to not be retired, and the next-in-sequence target page MP001 is programmed (block 240, FIG. 2) with data transmitted over the bus interface 122 (FIG. 1) by the storage controller 116 using an appropriate program command string in a manner similar to that described above in connection with the previous target page MP000 as shown in FIG. 3. Similarly, the remaining in-sequence pages MP002 . . . . MP015 of the layer 310ₐ of pages of block 310 are each in turn determined (block 230, FIG. 2) to not be retired, and programmed (block 240, FIG. 2) with data transmitted over the bus interface 122 as shown in FIG. 3, using appropriate program command strings in a manner similar to that described above in connection with the previous in-sequence target pages MP000, MP001. The programming of each active target page MP000-MP015 with host data transmitted over the bus interface 122 is represented in FIG. 3 by a solid line box outlining each quadruple of shared pages of the layer 310ₐ of target pages MP000-MP015.

However, in this example, the pages MP016-MP031 and MP032-MP047 (FIG. 3A) of the next two layers 310_{b}, 310_{c}, respectively, are not active but instead have been retired by the storage controller 116. Thus, after the active page MP015 has been programmed (block 240, FIG. 2) with data transmitted over the bus interface 122 as described above, and the page counter p is incremented (block 260, FIG. 2) so that the page counter incremented as p=p+1, points to the next page MP016 as the next-in-sequence target page of the block 310 to be programmed, it is determined (block 230, FIG. 2) that the next-in-sequence target page MP016 of the layer 310_{b} of the block 310 is not active, that is, that it has been retired. Accordingly, in one aspect of pseudorandom data programming in accordance with the present description, instead of programming the retired, next-in-sequence target page MP016 of the block 310 with pseudorandom data transmitted over the bus interface 122, the storage controller issues an appropriate command or command string to the device 106 to program (block 270, FIG. 2) page p=MP016 with on-board die pseudorandom data, that is, pseudorandom data which is already pre-stored on the die 112. As result, since the page MP016 is programmed with on-board pseudorandom data already residing on the die 112, transmission of pseudorandom data over the bus interface 122 for purposes of programming the retired page MP016 may be substantially reduced or eliminated for such retired pages. Accordingly, it is believed that a beneficial reduction in traffic over the bus interface 122 may be achieved so that increased bus bandwidth may be made available for the benefit of other memory operations. The programming of the target page MP016 with on-board pseudorandom data is represented in FIGS. 3, 3A by a dotted line box outlining the quadruple of shared pages which include target page MP016 of the memory block 310.

In one embodiment, the storage controller 116 pre-stores pseudorandom data as pseudorandom data which is on-board the die 112, in an internal buffer such as an on-board reference block 320 (FIG. 3) of on-board reference pages of NAND type memory cells of the die 112 (FIG. 1). The reference blocks of QLC memory cells in this example, are written once and are used for all QLC memory blocks with retired pages or with open layers. In one embodiment, the reference blocks may be updated periodically with new patterns of on-board pseudorandom data.

In the illustrated embodiment, the pages addresses RPx of the on-board reference block 320 are arranged in a matrix and the addresses RPx of each on-board reference page are sequentially numbered as RPx=RP000, RP001 . . . . RPₙ of an array of NAND type memory cells of a die 112 (FIG. 1). In a manner similar to that of the target block 310, the reference pages located at the page addresses RP000, RP001 . . . . RPₙ of the reference block 320 are referred to herein as simply the on-board reference pages RP000, RP001 . . . . RPₙ, respectively, for simplicity sake. Also, the on-board reference pages RP000, RP001 . . . . RPₙ of the reference block 320 are arranged in layers 320ₐ, 320_{b} . . . 320ₙ in this example. Each layer 320ₐ, 320_{b} . . . 320ₙ in this example, includes 4 quadruples of shared pages per layer. In one embodiment, each die has four reference blocks 320 per plane in which the reference block 320 is representative of one such reference block. It is appreciated that the organization of reference blocks of pseudorandom data in a memory may vary depending upon the particular application. For example, the number of pages per layer may vary, the number of layers per block may vary, the number of pages per block may vary, etc.

In the illustrated embodiment, the on-board reference block 320 may utilize a variety of different types of memory cells such as QLC or SLC type memory cells, for example. It is appreciated that the on-board reference block 320 may be implemented with other types of memory cells on board the memory die 112, depending upon the particular application. The programming of each on-board reference page RP000-RPₙ of the on-board reference block 320 with pseudorandom data, is represented by a dotted line box outlining each quadruple of shared pages of the on-board reference pages RP000-RPₙ of the reference block 320.

In one embodiment, the storage controller 116 generates the pseudorandom data to be stored on-board the memory die 112 in the reference block 320 using a randomizer circuit 121 (FIG. 1) to randomize a seed string. In one embodiment, the page address of each page of the reference block 320 may be used as a seed string which is randomized by the randomizer circuit 121 to generate pseudorandom data for the associated reference page of block 320. The pseudorandom data generated by the storage controller 116 is pre-stored on the memory die 112 by transferring the storage controller generated pseudorandom data over the bus interface 122 to the memory die 112. In another aspect of pseudorandom data programming in accordance with the present description, the pseudorandom data stored in the reference block 320 may be generated on-board the memory die 112 by one or more pseudorandom data generators on board the memory die 112 as discussed below in connection with FIGS. 1A, 4D. It is appreciated that pseudorandom data may be generated using a variety of techniques, depending upon the particular application.

In one embodiment, the reference block 320 is contained in a portion of the total array of memory cells within the memory die. This portion of memory cells is reserved for storing pseudorandom data as on-board die pseudorandom data, which is stored in advance of programming other portions of the die 112 with other data such as user data, for example. In some applications, one or more reference blocks are reserved in each of the planes 114i in each die 112 of each device 106i and are used for internal copying of pseudorandom data to retired or active pages in memory blocks located in the same planes 114i as the reference blocks.

In this embodiment, the layers 320ₐ, 320_{b} . . . 320ₙ have a one-to-one correspondence with a corresponding layer 310ₐ, 310_{b} . . . 310ₙ of the target block 310. However, it is appreciated that in other embodiments, each layer 310ₐ, 310_{b} . . . 310ₙ of the target block 310 may share an associated reference block layer or may have more than one reference block layer associated with the particular target block layer. Similarly, the layers 320ₐ, 320_{b} . . . 320ₙ of a reference block 320 may be associated with more than one target block.

FIG. 4B illustrates an example of a suitable command 420 issued by a storage controller such as the storage controller 116 of FIG. 1, to program (block 270, FIG. 2) retired page p=MP016 with on-board pseudorandom data which is already pre-stored on the die 112. In this example, a known flash memory command referred to as copyback read command 460 (FIG. 4C) may be first utilized to copy the data from the reference block to an on-board internal buffer. Thus, in this example, a command field 462 of the command issued by the storage controller 116 identifies the command as a copyback read command in which data that is stored in the reference block in the die 112 in a first, that is, source page identified by an address in a source address field 464, is meant to be copied or moved to an on-board buffer. Upon reception of command field 466, the on-die command controller 126 reads the data from the source page and stores the content in the on-board buffer. Note that in this embodiment, the copyback read command 460 lacks a data field, i.e., the controller 116 does not transfer the data from the on-board buffer to the internal state machine 120 over the interface 122. After the copyback read operation has been accomplished, a copyback program command can be employed. In this example, a command field 422 (FIG. 4B) of the command issued by the storage controller 116 identifies the command as a copyback program command in which data that was stored in the on-board buffer in the die 112 is copied or moved to a second, that is, target page as identified by a target address field 424. Upon reception of command field 426, the command controller 126 reads the data from on-board buffer and programs the content in the target page. Note that in this embodiment, the copyback commands 420, 460 lack a data field since the data being copied is already on-board the die.

Generally, copyback operations typically include a copyback read operation, and a copyback program operation. A copyback read operation reads data stored in a source page (identified by source address field 464, FIG. 4C) and stores it in an on-board page buffer. A copyback program operation can re-program the data stored in the on-board page buffer to the target page (identified by target address field 424, FIG. 4B) directly. In the illustrated embodiment, the controller 116 writes the retired pages in a target QLC block with the corresponding pseudorandom patterns from the reference QLC block (or SLC blocks) It is appreciated that the types of memory cells and associated copyback commands may vary, depending upon the particular application.

In one aspect of pseudorandom data programming in accordance with the present description, a verify operation to verify the integrity of the data movement operation may be omitted to speed up the completion of the internal movement from the source page of the NAND flash memory device to the target page. A known verify operation confirms whether data is correctly programmed to the target page. For example, data stored in the on-board page buffer may be read out by the storage controller and after correcting any errors, the controller can provide the corrected data to be programmed in the target page. It is appreciated that data verification operations are not needed for such copyback operations in many embodiments of pseudorandom data programming in accordance with the present description since the data being moved internally within the NAND flash memory device is non-user pseudorandom data. Hence, a limited number of errors occurring as a result of errors in the copyback read operation or the copyback program operation will typically be harmless since such errors will typically supplement or at least not substantially detract from the random nature of the pseudorandom data being moved from the reference block 320 to the target memory block 310.

In this example, the copyback commands 420 and 460 are used to cause the internal transfer of a single page from the reference block 320 to program a single page, that is target page MP016, in this example, with on-board pseudorandom data copied from the corresponding on-board reference page RP016 of the reference block 320 to program (block 270, FIG. 2) the retired memory page MP016 (FIG. 3A). The programming of the retired target page MP016 with pseudorandom data copied from a corresponding on-board reference page RP016 of the reference block 320 is represented in FIGS. 3, 3A by a dotted line box outlining the quadruple of shared pages which include the retired target page MP016 of the memory block 310 as shown in FIGS. 3, 3A. It is appreciated that in other examples and embodiments, multiple commands may be employed by a storage controller 116 to internally transfer multiple pages from the pseudorandom data reference block 320 to retired pages of the target block being programmed with pseudorandom data from the reference block, with a single command or command string.

Having programmed (block 270, FIG. 2) the retired page MP016 with on-board pseudorandom data copied from corresponding on-board reference page RP016 of the reference block 320, a determination (block 250, FIG. 2) is again made as to whether all the pages of the block have been programmed. In this example of FIG. 2, so far only pages MP000-MP016 have been programmed. Accordingly, the page counter p is incremented (block 260, FIG. 2) so that p=p+1 which points to the next-in-sequence page MP017 in the sequence of pages of the block 310 to be programmed. In this manner, page MP017 is identified as the next-in-sequence target page of the block 310 of pages for writing data.

As previously noted, in the illustrated embodiment, the pages MP016-MP047 have been retired by the storage controller 116. Accordingly, the next-in-sequence target page MP017 is determined (block 230, FIG. 2) to be retired, and the next-in-sequence target page MP017 (FIG. 3A) is programmed (block 270, FIG. 2) with on-board pseudorandom data copied from the corresponding on-board reference page RP017 of the reference block 320 by the storage controller 116 using an appropriate read and program command string in a manner similar to that described above in connection with the previous retired target page MP016. Similarly, the remaining in-sequence pages MP018-MP047 (FIG. 3A) of the layers 310_{b}, 310_{c} of pages of block 310 are each in turn determined (block 230, FIG. 2) to be retired, and programmed (block 270, FIG. 2) with on-board pseudorandom data copied from the associated pages RP018-RP047, respectively, of the reference block 320, using appropriate read and program command strings in a manner similar to that described above in connection with the previous in-sequence retired target pages MP016, MP017. The programming of retired target page MP016-MP047 with pseudorandom data from the reference block 320 is represented in FIGS. 3, 3A by a dotted line box outlining each quadruple of shared pages of the retired target pages MP016-MP047 of the memory block 310 as shown in FIGS. 3, 3A.

Having programmed the retired pages of retired layers 310_{b} 310_{c}, a determination (block 250, FIG. 2) is again made as to whether all the pages of the block have been programmed. In this example of FIG. 2, so far only pages MP000-MP047 have been programmed.

Accordingly, the page counter p is incremented (block 260, FIG. 2) so that p=p+1 which points to the next page MP048 in the sequence of pages of the block 310 to be programmed. In this manner, page MP048 is identified as the next-in-sequence target page of the block 310 of pages for writing data.

In the illustrated example, the pages of the remaining layers 310_{c} . . . 310ₙ are each active, that is, not retired. Accordingly, the next-in-sequence target page MP048 is determined (block 230, FIG. 2) to not be retired, and the next-in-sequence target page MP048 is programmed (block 240, FIG. 2) with host data transmitted over the bus interface 122 (FIG. 1) by the storage controller 116 using an appropriate program command string in a manner similar to that described above in connection with the earlier in-sequence active target pages MP000-MP015. Similarly, the remaining in-sequence pages of the layers 310 . . . 310, of pages of the block 310 are each in turn determined (block 230, FIG. 2) to not be retired, and programmed (block 240, FIG. 2) with, in this example, host data transmitted over the bus interface 122 using appropriate program command strings in a manner similar to that described above in connection with the previous in-sequence active target pages MP000-MP015, MP048. The programming of the active target page MP048-MPₙ with host data transmitted over the bus interface 122 is represented by a solid line box outlining each quadruple of shared pages of the active target pages MP048-MPₙ of the memory block 310 as shown in FIG. 3. Upon determining (block 250, FIG. 2) that all the active and retired pages of the block 310 have been sequentially programmed, the programming of the block 310 is complete (block 280, FIG. 2) as shown in FIG. 3.

FIG. 4D shows an example in which the state machine 120 of the storage controller 116 has been modified to generate an interface command string 440 in accordance with one aspect of pseudorandom data programming of the present description. In this example, the command controller 126 of each die 112 is modified to execute the command string 440, to provide for internally generating one or more on-board reference pages to program multiple retired or active pages of the target block 310 with on-board die pseudorandom data. Thus, the interface command string 440 provides for programming a range of page addresses in a block with pseudorandom data generated on-board the memory die 112, such that the controller 116 need not send the pseudorandom data to the storage die for the programming operation thus reducing the latency of the command and the traffic on the I/F bus 122.

In the illustrated embodiment, the program command string 440 (FIG. 4D) includes a command field 442 which identifies the command as a multiple page on-board pseudorandom data generation command, a target address field 444 which identifies the starting address or addresses of the target page or pages to be programmed with on-board generated pseudorandom data, a page number address field 446 which identifies the number of target pages to be programmed, and a pattern identification (ID) address field 448 which identifies the pattern of on-board pseudorandom data to be programmed to the target pages or pages. In the illustrated embodiment, the pattern ID may identify a particular on-board pseudorandom data generator of a set of on-board pseudorandom data generators ID₁, ID₂ . . . . IDₙ (FIG. 1A) which are on-board the memory die 112 and configured to generate patterns of pseudorandom data from a set of pseudorandom data patterns. Thus, a particular pattern of pseudorandom data may be selected to program a retired page or pages, for example, by selecting the particular on-board pseudorandom data generator which has been configured to generate that particular pattern of pseudorandom data from a seed pseudorandom data pattern. The pseudorandom data output of the selected pseudorandom data generator may be transferred directly to the target page or pages to be programmed. Alternatively, pseudorandom data output of the selected pseudorandom data generator may be transferred to populate on-board reference block pages of the reference block 320 for subsequent transfer to the target page or pages. In another embodiment, the pattern ID may include for example, the address of a starting page or pages of the reference block 320 associated with the starting address of a corresponding target memory page or pages to be programmed with on-board pseudorandom data.

A second command identified by a field 450 of the string 440 causes the target die 112 to execute the programming of the command string 440. Thus, in the example of FIG. 3A, the command string 440 can instruct the recipient die 112 containing the on-board generated pseudorandom data to program (block 270, FIG. 2) N=32 retired target pages as identified the page quantity field 446, starting at retired target memory page MP016 as identified by target address field 444, using on-board pseudorandom data generated by the identified on-board pseudorandom data generator ID₁, ID₂ . . . . IDₙ (FIG. 1A) as identified by the pattern ID field 448 of the program command string 440.

If N, the number of pages being programmed by the command 440 (FIG. 4D) with on-board pseudorandom data is greater than 1 (N>1), the page counter p is incremented (block 260, FIG. 2) so that p=p+N instead of p=p+1. As a result, the page counter p points to the next target page in the sequence of pages of the target block 310 to be programmed, following the programming of the N pages with the on-board generated pseudorandom data. In this example, if N=32, the number of pages being programmed by the command 440 (FIG. 4D) with on-board generated pseudorandom data, the page counter p is incremented (block 260, FIG. 2) so that p=16+32=48 so that the page counter points to the next target page MP048 in the sequence of pages of the block 310 to be programmed, following the programming of the N=32 target memory pages MP0016-MP047 with the on-board generated pseudorandom data generated by the identified on-board pseudorandom data generator ID₁, ID₂ . . . . IDₙ (FIG. 1A) as identified by the pattern ID field 448 of the program command string 440. In this manner, contiguous retired pages of the target block 310 may be programmed with on-board generated pseudorandom data sourced from an identified on-board pseudorandom data generator ID₁, ID₂ . . . . IDₙ (FIG. 1A), using a single command string such as the command 440 of FIG. 4D. In this example, two layers 310_{b}, 310_{c} of retired pages were programmed with on-board generated pseudorandom data using the single command string of FIG. 4D. The programming of the retired target pages MP016-MP047 with on-board generated pseudorandom data is represented in FIGS. 3, 3A by a dotted line box outlining each quadruple of shared pages which include the retired target pages MP016-MP047 of the memory block 310. It is appreciated that in other embodiments or applications other units or sub-units of a target block may be programmed by a multiple page on-board pseudorandom data generation and programming command, such as programming a fewer or greater number of layers of retired pages, or programming a portion of a layer, for example. Furthermore, interface command string 440 can be extended for single plane or multi-plane operations, can support one-pass and multi-pass program algorithms, and can be defined for a variety of interfaces including the Open NAND Flash Interface Working Group (ONFI) and TOGGLE interfaces.

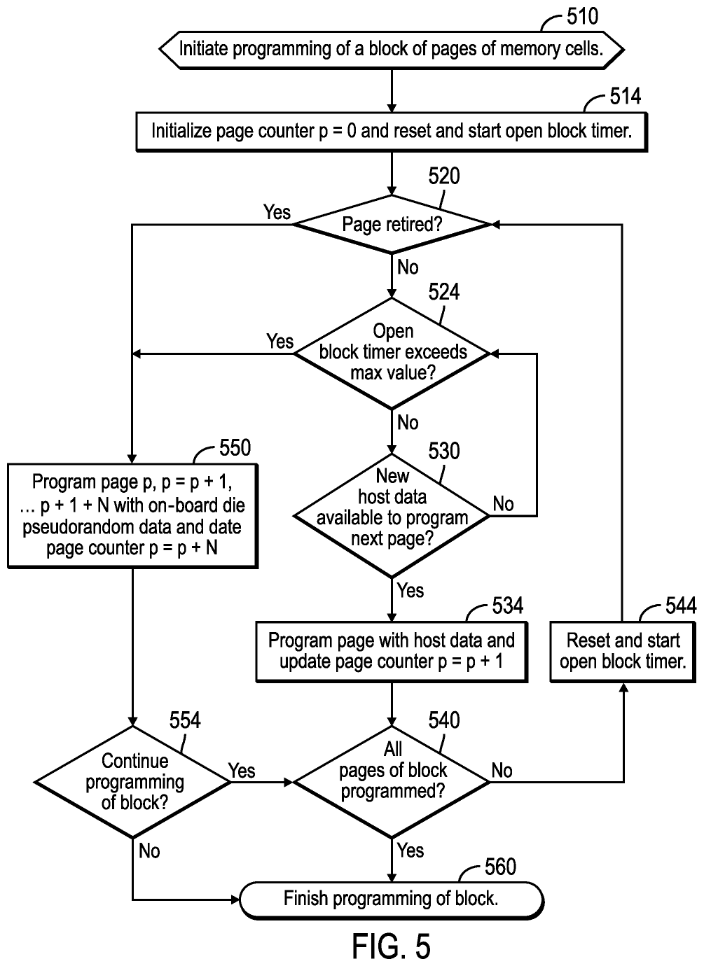

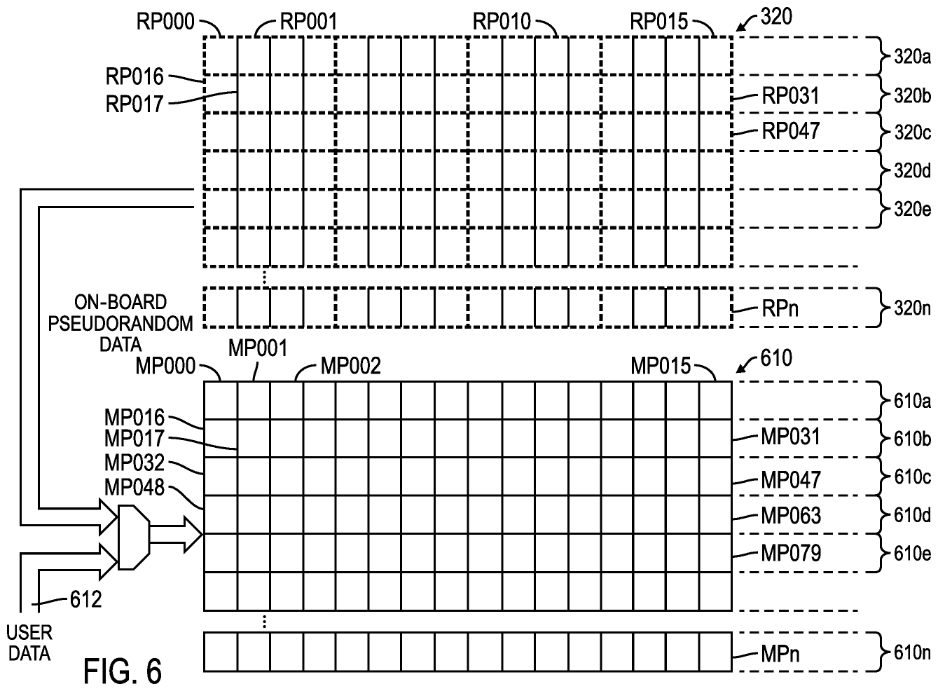

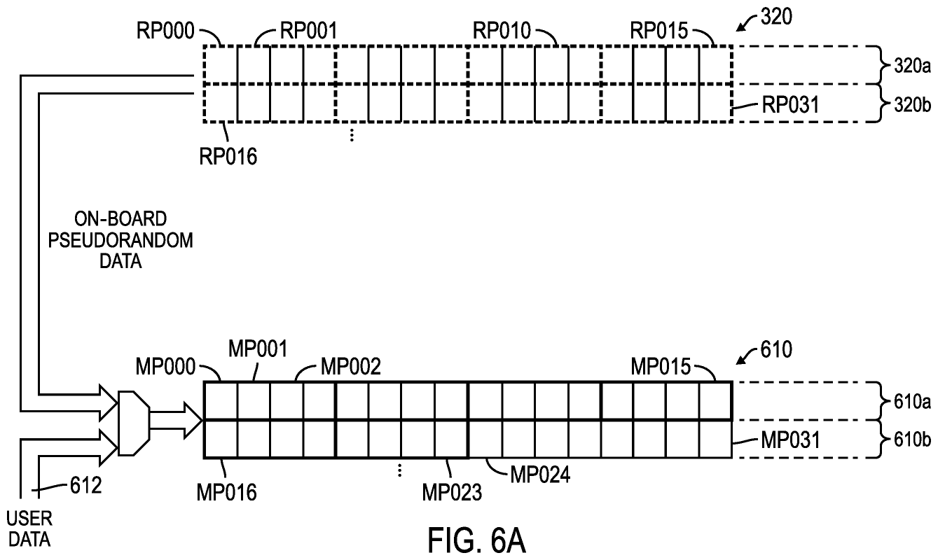

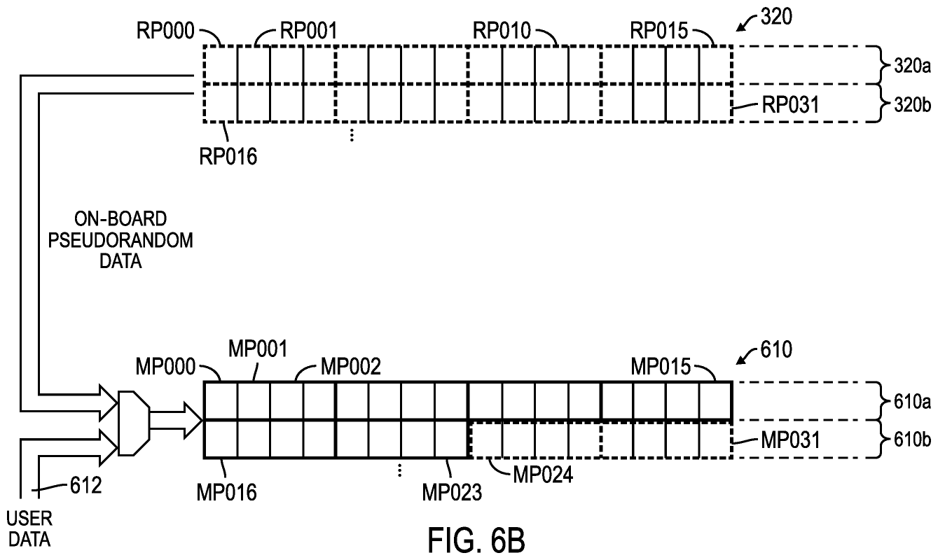

FIG. 5 illustrates another example of operations performed by the storage controller 116 (FIG. 1), in programming pages of a target block 610 (FIG. 6) of an array of memory cells of a memory device, in accordance with another aspect of pseudorandom data programming of the present description. As explained in greater detail below, in this example, active pages are selectively programmed with on-board pseudorandom data. In one embodiment, an open block timer records the time between subsequent page program operations programming host data for a particular block. Upon determining that the timer has exceeded a threshold value, the next page address in the block may be programmed using on-board die pseudorandom data either generated on-board or pre-stored on-board, instead of leaving the page in its erased state while awaiting a further host data programming operation. In this manner, neighboring pages adjacent the last programmed layer of an open block may be programmed using on-board die pseudorandom data. As a result, it is believed that the reliability of the pages in the last programmed layer of pages may be improved.

As shown in FIG. 5, the operations of the storage controller 116 in this example are represented by blocks 510-560 of FIG. 5. It is appreciated that the number and types of operations of a storage controller 116 in accordance with embodiments of the present description, may vary, depending upon the particular application. Furthermore, operations may be performed in sequences other than those depicted in FIG. 5. For example, selected operations may be performed in reverse order or substantially in parallel, depending upon the particular application.

In the embodiment of FIG. 5, the operations include initiating (block 510, FIG. 5) programming of a target block of pages of an array of memory cells. FIG. 6 depicts an example of a block 610 of memory pages to be programmed which is initially erased in its entirety so that each page at page addresses MP000 . . . . MPₙ of the block 610 of memory pages being programmed, is initially in an erased state prior to being programmed. The initial erased state of the pages at page addresses MP000, MP001 . . . . MP0n (or simply pages MP000, MP001 . . . . MPₙ) of the target memory block 610 is represented in FIG. 6 by the lack of either a solid line box outlining the page (which represented being programmed with host data), or a dotted line box outlining the page (which represented being programmed with on-board pseudorandom data).

In a manner similar to that described in connection with FIG. 2, the initially erased pages MP000, MP001 . . . . MP0ₙ (FIG. 6) of a block 610 are programmed by the storage controller 116 (FIG. 1) sequentially starting at the first page MP000 of the sequence of pages of the block 610 and programming each subsequent page in a defined sequence of the page program order. Accordingly, a page counter p is initialized (block 514, FIG. 5) at p=0 which points to the first erased target page MP000 (FIG. 6) of the sequence of target pages of the block 610. In this manner, page MP000 is identified as the initial target page of the block 610 of pages for writing data. In another aspect of pseudorandom data programming in accordance with the present description, an open block timer 140 (FIG. 1) of the state machine 120 is reset and started to begin timing an interval of time as explained below.

In the previously discussed example of FIGS. 2, 3 and 3A, the in-sequence pages MP000-MP015 of the layer 310ₐ, and the pages MP048-MP079 of the layers 310_{d}, 310ₑ of the block 310, were determined (block 230, FIG. 2) to be active in that example. As a result, the in-sequence pages MP000-MP015 of the layer 310ₐ and the pages MP048-MP079 of the layers 310ₐ, 310ₑ of the block 310 were programmed (block 240, FIG. 2) in that example with host data transmitted over the bus interface 122. However, FIG. 5 is directed to another example in which the host data for programming active pages of the active layers of the block 610 may not be available before expiration of a timer interval timed by the open block timer 140. As explained in greater detail below, in another aspect of pseudorandom data programming in accordance with the present description, in the event that host data for programming a target page is not available before expiration of the timed interval, the particular active target page is programmed with on-board die pseudorandom data either generated on-board or pre-stored on-board the memory die 112 instead of host data, to increase reliability of the previously programmed layer.

A determination (block 520, FIG. 5) is made as to whether the page at p=0, that is target page MP000 of block 610 in this example, is retired. In this example, the storage controller 116 (FIG. 1) determines (block 520, FIG. 5) that the target page MP000 is not retired, that is, that the target page MP000 remains active. It is appreciated that in some embodiments, the memory system may be limited to retiring an entire block at a time and thus may lack the feature of retiring portions of a block, such as pages or layers of pages. In such embodiments, the determination (block 520, FIG. 5) of whether a target page is retired, may be omitted. It is further appreciated that the determination (block 520, FIG. 5) of whether a target page is retired, may be omitted in other embodiments, depending upon the particular application.

Having determined (block 520, FIG. 5) that the target page MP000 remains active, a further determination is made as to whether (block 524, FIG. 5) the timer interval being timed by the open block timer 140 (FIG. 1) has expired. If not, a determination (block 530, FIG. 5) is made as to whether new host data is available to program the current target page, that is, the target page MP000 in this example. If so, the storage controller 116 sends an appropriate page program command string such as the page program command string 400 (FIG. 4A) discussed above, to program (block 534, FIG. 5) the current target page MP000 with host data. The page program command string 400 transmits the host data over the bus interface 122 (FIG. 1) to the die 112 which has the target block 610 (FIG. 6) of an array of memory cells to be programmed. The data received over the bus interface 122 is represented as “User Data” 612 in FIG. 6.

Once the data of the data field 406 (FIG. 4A) has been loaded in the target die 112 (FIG. 1) and the target page identified by the address field 404 (FIG. 4A) selected, a second command of the field 408 of the string 400 causes the target die 112 to execute the programming of the received data in the selected target page. In this example, the program command string 400 programs a single page, that is target page MP000 of the target block 610 with the data contained within the field 406 which is transmitted over the bus interface 122 (FIG. 1) to the die 112. The programming of the active target page MP000 of the memory block 610 with host data transmitted over the bus interface 122 is represented in FIG. 6A by a solid line box outlining the quadruple of shared pages which include the target page MP000. Furthermore, although the program command string 400 is described in this example of programming a single page, it is appreciated that in other examples and embodiments, multiple program command strings may be employed by a storage controller 116 to program (block 534, FIG. 5) multiple pages.

In connection with the programming of the current active target page MP000 with host data, the page counter p is incremented (block 534, FIG. 5) as p=p+1 so that the page counter points to the next page MP001 in the sequence of pages of the block 610 to be programmed. In this manner, page MP001 is identified as the next-in-sequence target page of the block 610 of pages for writing data.

In this example, it is determined (block 540, FIG. 5) that not all the pages of the block have been programmed. Accordingly, the open block timer 140 is reset (block 544, FIG. 5) and a new open block timer interval is started or re-initiated.

In the illustrated embodiment, the pages MP000, MP001 . . . . MP015 (FIG. 6) of the top layer 610ₐ of pages of the block 610 are each active, that is, not retired. Accordingly, for the next-in-sequence target page MP001, it is determined in this example, that the page MP001 is not retired (block 520, FIG. 5), the open block timer 140 (FIG. 1) is not expired (block 524, FIG. 5), and that new host data to program the page MP001 is available (block 530, FIG. 5). Accordingly, the current and next-in-sequence target page MP001 is programmed (block 534, FIG. 2) with new host data transmitted over the bus interface 122 (FIG. 1) by the storage controller 116 using an appropriate program command string in a manner similar to that described above in connection with the previous target page MP000. The programming of the active target page MP001 with host data transmitted over the bus interface 122 is represented in FIG. 6A by a solid line box outlining the quadruple of shared pages which include the target page MP001.

In addition, the page counter p is incremented (block 534, FIG. 5) as p=p+1 so that the page counter points to the next-in sequence page MP002 in the sequence of pages of the block 610 to be programmed. Since not all pages have been programmed (block 540, FIG. 5), the open block timer 140 is reset (block 544, FIG. 5) and a new open block timer interval is started.

In this example, the remaining in-sequence pages MP002 . . . . MP015 of the layer 610ₐ of pages of block 610 and the pages MP016-MP023 of the next-in-sequence layer 610_{b} are each in turn determined (block 520, FIG. 5) to not be retired, the open block timer 140 (FIG. 1) is not expired (block 524, FIG. 5) since the last page was programmed, and that new host data to program the pages MP002 . . . . MP015 of the layer 610ₐ and the pages MP016-MP023 of the next-in-sequence layer 610_{b} is available (block 530, FIG. 5) for each of the pages MP016-MP023. Accordingly, the pages MP002 . . . . MP023 of the layers 610ₐ, 610_{b} are programmed (block 534, FIG. 5) with data transmitted over the bus interface 122 using appropriate program command strings in a manner similar to that described above in connection with the previous in-sequence target pages MP000, MP001. The programming of the active target pages MP002-MP023 with host data transmitted over the bus interface 122 is represented in FIG. 6A by a solid line box outlining each quadruple of shared pages which include the target pages MP002-MP023. In addition, the page counter p is incremented (block 534, FIG. 5) in connection with the programming of the target pages MP002-MP023 so that the page counter p points to the next-in sequence page MP024 in the sequence of pages of the block 610 to be programmed.

In this example, following the programming of the target pages MP002-MP023, it is again determined (block 540, FIG. 5) that not all the pages of the block have been programmed. Accordingly, the open block timer 140 is reset (block 544, FIG. 5) and a new open block timer interval is started. A determination (block 520, FIG. 5) is made as to whether the next-in sequence page MP024 of block 610 is retired. In this example, the storage controller 116 (FIG. 1) determines (block 520, FIG. 5) that the target page MP024 is not retired, that is, that the target page MP024 remains active.

Having determined (block 520, FIG. 5) that the current target page MP024 remains active, a further determination is made as to whether (block 524, FIG. 5) the timer interval being timed by the open block timer 140 (FIG. 1) has expired. If not, a determination is made as to whether (block 530, FIG. 5) new host data is available to program the current target page, that is, the target page MP024 in this example. In this example, it is determined (block 530, FIG. 5) that new host data is not available to program the current in-sequence target page MP024. In the absence of host data being available for the storage controller 116 to program the current target page MP006 with host data, the current target page MP024 remains in the erased state as indicated in FIG. 6A until the timing interval timed by the open block timer 140 is determined (block 524, FIG. 5) to have expired.

It is believed that an open layer such as the layer 610_{b} of the target block 610 in which programming of the layer remains incomplete, can have an adverse effect on the reliability of the previously programmed, neighboring layer 610ₐ. In one aspect of pseudorandom data programming in accordance with the present description, once it is determined (block 524, FIG. 5) that the open block timing interval has expired without host data being available to program the current target page, the current active in-sequence target page MP024 is programmed (block 550, FIG. 5) with on-board die pseudorandom data as indicated in FIG. 6B, instead of allowing the current target page MP024 to remain in the erased state shown in FIG. 6A beyond the expiration of the timed interval. As such, it is believed that the reliability of the pages in the last programmed layer, that is layer 610ₐ, in this example, is improved. The programming of the target page MP024 with pseudorandom data is represented in FIG. 6B by a dotted line box outlining the quadruple of shared pages which include the target page MP024 of the memory block 610.

In one embodiment, the interval being timed by the open block timer 140 has a predetermined duration or threshold value of approximately one hour. It is appreciated that other durations may be utilized depending upon the particular application. For example, in one embodiment, the interval being timed by the open block timer 140 may have a duration in a range from approximately one hour to approximately two hours. It is appreciated that the timer 140 may record the time elapsed between the programming of two successive pages in the page program sequence, e.g., page MP000 and page MP001 in block 610, or the time elapsed between the programming of two successive sets of shared pages in the page program sequence, e.g., shared pages MP000-MP003 and shared pages MP004-MP007 in block 610, or the time elapsed between the programming of two successive layers in the page program sequence, e.g., layer 610ₐ and layer 610_{b} in block 610.

In one aspect of pseudorandom data programming in accordance with the present description, instead of programming the current, active, in-sequence target page MP024 of the block 310 with pseudorandom data transmitted over the bus interface 122, the storage controller issues an appropriate command or command string to the die 112 to program (block 550, FIG. 5) the current target page p=MP024 with on-board die pseudorandom data, that is, pseudorandom data which is generated on the die 112 or already pre-stored on the die 112. As result, since the current target page MP024 is programmed with on-board die pseudorandom data already residing on the die 112, transmission of pseudorandom data over the bus interface 122 for purposes of programming the active page MP024 may be substantially reduced or eliminated for such active pages. As such a corresponding beneficial reduction in traffic over the bus interface 122 may be achieved so that increased bus bandwidth is available for the benefit of other memory operations.

In one embodiment, the storage controller 116 pre-stores pseudorandom data as pseudorandom data which is on-board the die 112, in the reference block 320 (FIGS. 6, 6A, 6B) of reference pages at addresses RPx of NAND type memory cells of a die 112 (FIG. 1), as previously discussed in connection with FIGS. 3, 3A. The programming of each reference page at addresses RP000-RPₙ with pseudorandom data is represented by a dotted line box outlining each quadruple of shared pages of the reference pages RP000-RPₙ of the reference block 320.

In another aspect of pseudorandom data programming in accordance with the present description, one or more pages of pseudorandom data may be generated on-board the storage die 112 to program multiple pages of the target block 610 with on-board die generated pseudorandom data, to complete the programming of the remaining unprogrammed pages of the open layer 610_{b} of the target block 610, to increase the reliability of the previously programmed neighboring layer 610ₐ. Moreover, the generating and programming of multiple target pages with multiple pages of on-board generated pseudorandom data to complete an open layer such as the open layer 610_{b} as shown in FIG. 6A of the target block may be accomplished with a single command string such as page command string 440 of FIG. 4D discussed above. It is appreciated that in other embodiments, pages of on-board pseudorandom data may be generated and programmed one page at a time with a suitable page command string modified as appropriate, to complete an open layer of the target block.

Thus, in one embodiment a single command string such as the command string 440 of FIG. 4D, may be utilized to program (block 550, FIG. 5) multiple target pages p, p+1 . . . p+N-1 with on-board generated pseudorandom data to program remaining unprogrammed pages of an open layer. In this example, the remaining unprogrammed pages of the open layer 610_{b} are pages at addresses MP024-MP031 as shown in FIG. 6A. To program these pages with on-board generated pseudorandom data using the multi-page programming command 440 of FIG. 4D, the target address field 444 of the command 440 is configured to identify the starting address of the target page MP024, the page number address field 446 is configured to identify the number of target pages to be programmed as N=8, in this example, and the pattern ID address field 448 is configured to identify the pattern of on-board generated pseudorandom data to be programmed to the target pages.

Thus, in the example of FIG. 6A, the command string 440 can instruct the recipient die 112 containing the target memory block 310 to program (block 550, FIG. 5) N=8 active target pages as identified by the page quantity field 446, starting at active target memory page MP024 as identified by target address field 444, using the on-board generated pseudorandom data identified by the pattern ID field 448 of the program command string 440. FIG. 6B depicts the target pages MP024-MP031 as programmed with on-board generated pseudorandom data generated by the identified on-board pseudorandom data generator ID₁, ID₂ . . . . IDₙ (FIG. 1A). In this manner, the previously open layer 610_{b} of FIG. 6A is closed as depicted in FIG. 6B by the programming of these pages with on-board generated pseudorandom data, to increase the reliability of the previously programmed layer 610ₐ in the absence of sufficient host data to complete the programming of the open layer 610_{b} in a timely manner.

In this example, the number of pages being programmed by the command 440 (FIG. 4D) with on-board generated pseudorandom data is N. Accordingly, the page counter p is updated (block 550, FIG. 5) so that p=p+N such that the page counter points to the next page in the sequence of pages of the block 310 to be programmed, following the programming of the N pages with the on-board pseudorandom data. In this example, N=8, the number of pages being programmed by the command 440 (FIG. 4D) with on-board generated pseudorandom data, and the page counter p is updated (block 550, FIG. 5) so that p=24+8=32 so that the page counter points to the next page MP032 in the sequence of pages of the block 310 to be programmed, following the programming of the N=8 memory pages MP024-MP031 with the on-board generated pseudorandom data.

In this manner, all the remaining unprogrammed and contiguous active pages of the open memory layer 610_{b} of the target block 310 may be programmed with on-board generated pseudorandom data sourced from an identified on-board pseudorandom data generator ID₁, ID₂, . . . . IDₙ (FIG. 1A), using a single command string such as the command 440 of FIG. 4D. The programming of the active target pages MP024-MP031 with on-board generated pseudorandom data is represented in FIG. 6B by a dotted line box outlining each of the quadruple shared pages which include the active target pages MP024-MP031 of the memory block 310. It is appreciated that in other embodiments or applications other units or sub-units of a target block may be programmed by a multiple page on-board generated pseudorandom transfer command, such as programming a fewer or greater number of layers of active pages, or programming a greater or lesser portion of a layer, for example.

In one embodiment, a determination (block 554, FIG. 5) may be made as to whether to continue to program the block. If not, the programming of the block may be terminated (block 560, FIG. 5). It is appreciated that in some applications, it may be appropriate to provide the option of not continuing the programming of a particular block of memory. If it is determined (block 554, FIG. 5) to continue programming of the block, the remaining pages of the target block may be programmed in a similar fashion. Upon determining (block 540, FIG. 5) that all the active and retired pages of the block 610 have been sequentially programmed, the programming of the block 610 is complete (block 560, FIG. 5).

The on-board pseudorandom data programming operations of block 550 of FIG. 5 have been described in one embodiment, in connection with a multiple page on-board pseudorandom transfer command such as that described in connection with FIG. 4D. It is appreciated that in other embodiments, a single page on-board generated pseudorandom data programming command may be utilized to cause the generation and transfer of a single page of on-board generated pseudorandom data to program a single target page to program active pages with on-board generated pseudorandom data to improve the reliability of neighboring layers already programmed. In another embodiment, the multiple page on-board generated pseudorandom data command of FIG. 4D may be utilized to populate the reference block 320 for subsequent transfer to program active and retired pages to increase reliability.

FIG. 7 illustrates an embodiment of a system 700 in which the non-volatile memory storage device 100 of FIG. 1 may be deployed as the system memory device 708 and/or a storage device 710. The system 700 includes a processor 704 that communicates over a bus 706 with a system memory device 708 in which programs, operands and parameters being executed by the processor 704 are cached, and a storage device 710, which may comprise a solid state drive (SSD) that stores programs, operands, parameters, and user data that may be loaded into the system memory 708 for execution by the processor 704. One or both of the system memory device 708 and/or a storage device 710 may be programmed with on-board pseudorandom data to increase reliability as previously discussed. The processor 704 may also communicate with Input/Output (I/O) devices 712a, 712b, which may comprise input devices (e.g., keyboard, touchscreen, mouse, etc.), display devices, graphics cards, ports, network interfaces, etc. The memory 708 and storage device 710 may be coupled to an interface on the system 700 motherboard, mounted on the system 700 motherboard, or deployed in an external memory device or accessible over a network.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The letter designators, such as i, j, k, p, n, among others, used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A memory system for use with a host, comprising:
a plurality of storage dies having blocks of pages of memory for storing data;
a memory controller coupled to the plurality of storage dies and having a processor; and
a computer program product which comprises a computer readable storage medium having program instructions embodied therewith, the program instructions executable by a processor to cause operations, the operations comprising:
in response to receiving by the memory controller from a host, write data to be written to a storage die, initiating writing data to a target block of pages of the storage die including initiating a page counter to identify a target page of a sequence of target pages of the target block of pages of the storage die for writing data to the target block;
selecting a first target page of the sequence of target pages of the target block of pages of the storage die to write data, as a function of the page counter;
determining whether the selected first target page is a retired page instead of an active page; and
in response to a determination that the selected first target page is a retired page instead of an active page, writing on-board die pseudorandom data to the selected first target page which is retired, and updating the page counter to select a second in-sequence target page of the target block of pages of the storage die to write data.

2. The memory system of claim 1 wherein each storage die has at least one pseudorandom data generator on-board the storage die, and wherein the operations further comprise generating the on-board die pseudorandom data using a pseudorandom data generator on-board the storage die.

3. The memory system of claim 2 wherein writing on-board die pseudorandom data to the selected first target page includes the memory controller issuing a command to the storage die wherein the command has parameters which include an address of a target page, and a pattern identification (ID) which identifies a pseudorandom data generator of a plurality of pseudorandom data generators on-board the storage die, to generate a pattern of pseudorandom data.

4. The memory system of claim 3 wherein the parameters of the command further include a parameter identifying the number of pages of on-board die pseudorandom data to be written to target pages.

5. The memory system of claim 1 wherein each storage die has an internal source buffer, and wherein the operations further include the memory controller pre-storing pseudorandom data in an internal source buffer of the storage die so that the pre-stored pseudorandom data is on-board the internal source buffer of the storage die prior to initiating writing data to the target block of pages of the storage die.

6. The memory system of claim 1 wherein the operations further comprise:
in response to a determination that the selected first target page is an active page instead of a retired page, writing received host write data to the selected first target page of the storage die and updating the page counter to select a second in-sequence target page of the target block of pages of the storage die to write data.

7. The memory system of claim 6 wherein the operations further comprise:
in association with updating the page counter to select a second in-sequence target page of the target block of pages of the storage die to write data, initiating timing of an interval of time;
determining whether the timed interval of time has exceeded a predetermined interval of time; and
in response to determining that the timed interval of time has exceeded the predetermined interval of time, writing on-board die pseudorandom data to the selected second target page, and updating the page counter to select a third in-sequence target page of the target block of pages of the storage die to write data.

8. The memory system of claim 7 wherein the operations further comprise:
in response to determining that the timed interval of time remains within the predetermined interval of time, determining whether received host write data includes page write data available for writing to the selected second target page of the target block of pages of the storage die; and
in response to determining that received host write data includes page write data available for writing to the selected second target page of the target block of pages of the storage die, writing received host write data to the selected second target page of the storage die, updating the page counter to select a third in-sequence target page of the target block of pages of the storage die to write data, and resetting and re-initiating timing of an interval of time.

9. A memory system which includes a memory controller coupled to a plurality of storage dies having pages for storing data, wherein the memory system implements logic to perform operations with respect to the storage dies, the operations comprising:
in response to receiving by the memory controller from a host, write data to be written to the storage die, initiating writing data to a target block of pages of the storage die including initiating a page counter to identify a target page of a sequence of target pages of the target block of pages of the storage die for writing data to the target block;
selecting a first target page of the sequence of target pages of the target block of pages of the storage die to write data, as a function of the page counter;
determining whether the selected first target page is a retired page instead of an active page; and
in response to a determination that the selected first target page is a retired page instead of an active page, writing on-board die pseudorandom data to the selected first target page which is retired, and updating the page counter to select a second in-sequence target page of the target block of pages of the storage die to write data.

10. The memory system of claim 9 wherein the operations further comprise generating the on-board die pseudorandom data using a pseudorandom data generator on-board the storage die.

11. The memory system of claim 10 wherein writing on-board die pseudorandom data to the selected first target page includes the memory controller issuing a command to the storage die wherein the command has parameters which include an address of a target page, and a pattern identification (ID) which identifies a pseudorandom data generator of a plurality of pseudorandom data generators on-board the storage die, to generate a pattern of pseudorandom data.

12. The memory system of claim 11 wherein the parameters of the command further include a parameter identifying the number of pages of on-board die pseudorandom data to be written to target pages.

13. The memory system of claim 9 wherein the operations further include the memory controller pre-storing pseudorandom data in an internal source buffer of the storage die so that the pre-stored pseudorandom data is on-board the internal source buffer of the storage die prior to initiating writing data to the target block of pages of the storage die.

14. The memory system of claim 9 wherein the operations further comprise:
in response to a determination that the selected first target page is an active page instead of a retired page, writing received host write data to the selected first target page of the storage die and updating the page counter to select a second in-sequence target page of the target block of pages of the storage die to write data.

15. The memory system of claim 14 wherein the operations further comprise:
in association with updating the page counter to select a second in-sequence target page of the target block of pages of the storage die to write data, initiating timing of an interval of time;
determining whether the timed interval of time has exceeded a predetermined interval of time; and
in response to determining that the timed interval of time has exceeded the predetermined interval of time, writing on-board die pseudorandom data to the selected second target page, and updating the page counter to select a third in-sequence target page of the target block of pages of the storage die to write data.

16. The memory system of claim 15 wherein the operations further comprise:
in response to determining that the timed interval of time remains within the predetermined interval of time, determining whether received host write data includes page write data available for writing to the selected second target page of the target block of pages of the storage die; and
in response to determining that received host write data includes page write data available for writing to the selected second target page of the target block of pages of the storage die, writing received host write data to the selected second target page of the storage die, updating the page counter to select a third in-sequence target page of the target block of pages of the storage die to write data, and resetting and re-initiating timing of an interval of time.

17. A computer program product for a memory system for use with a host, the memory system comprising a plurality of storage dies having blocks of pages of memory for storing data, and a memory controller coupled to the plurality of storage dies and having a processor, the computer program product comprising a computer readable storage medium having program instructions embodied therewith, the program instructions executable by a processor to cause operations, the operations comprising:
in response to receiving by the memory controller from a host, write data to be written to a storage die, initiating writing data to a target block of pages of the storage die including initiating a page counter to identify a target page of a sequence of target pages of the target block of pages of the storage die for writing data to the target block;
selecting a first target page of the sequence of target pages of the target block of pages of the storage die to write data, as a function of the page counter;
determining whether the selected first target page is a retired page instead of an active page; and
in response to a determination that the selected first target page is a retired page instead of an active page, writing on-board die pseudorandom data to the selected first target page which is retired, and updating the page counter to select a second in-sequence target page of the target block of pages of the storage die to write data.

18. The computer program product of claim 17 wherein each storage die has at least one pseudorandom data generator on-board the storage die, and wherein the operations further comprise generating the on-board die pseudorandom data using a pseudorandom data generator on-board the storage die; and
wherein writing on-board die pseudorandom data to the selected first target page includes the memory controller issuing a command to the storage die wherein the command has parameters which include an address of a target page, a pattern identification (ID) which identifies a pseudorandom data generator of a plurality of pseudorandom data generators on-board the storage die, to generate a pattern of pseudorandom data, and a parameter identifying the number of pages of on-board die pseudorandom data to be written to target pages.

19. The computer program product of claim 17 wherein each storage die has an internal source buffer, and wherein the operations further include:
the memory controller pre-storing pseudorandom data in an internal source buffer of the storage die so that the pre-stored pseudorandom data is on-board the internal source buffer of the storage die prior to initiating writing data to the target block of pages of the storage die; and
in response to a determination that the selected first target page is an active page instead of a retired page, writing received host write data to the selected first target page of the storage die and updating the page counter to select a second in-sequence target page of the target block of pages of the storage die to write data.

20. The computer program product of claim 19 wherein the operations further comprise:
in association with updating the page counter to select a second in-sequence target page of the target block of pages of the storage die to write data, initiating timing of an interval of time;
determining whether the timed interval of time has exceeded a predetermined interval of time;
in response to determining that the timed interval of time has exceeded the predetermined interval of time, writing on-board die pseudorandom data to the selected second target page, and updating the page counter to select a third in-sequence target page of the target block of pages of the storage die to write data;
in response to determining that the timed interval of time remains within the predetermined interval of time, determining whether received host write data includes page write data available for writing to the selected second target page of the target block of pages of the storage die; and
in response to determining that received host write data includes page write data available for writing to the selected second target page of the target block of pages of the storage die, writing received host write data to the selected second target page of the storage die, updating the page counter to select a third in-sequence target page of the target block of pages of the storage die to write data, and resetting and re-initiating timing of an interval of time.
